(19) United States
(12) Patent Application Publication
(10) Pub. No.: US 2026/0277692 A1
(43) Pub. Date: Sep. 17, 2026

(54) DISABLING AN ARTIFICIAL-INTELLIGENCE MODULE (AI-MODULE) DEPENDENT ON A COMPUTATIONAL DEMAND FOR PERFORMING AN INFERENCE USING THE AI-MODULE

(71) Applicant: INTERNATIONAL BUSINESS MACHINES CORPORATION, ARMONK, NY (US)

(72) Inventors: Darko Zivkovic, Gärtringen (DE); Simon Flaig, Rottenburg (DE); Anastasiia Didkovska, Boeblingen (DE); Jakob Christopher Lang, Walddorfhäslach (DE); Dieter Wellerdiek, Ammerbuch (DE)

(21) Appl. No.: 19/181,387

(22) Filed: Apr. 17, 2025

(30) Foreign Application Priority Data
Mar. 13, 2025 (GB) 2503687.2

(51) Int. Cl. G06F 9/50; G06F 11/34

(52) U.S. Cl. CPC G06F 9/5038; G06F 9/5055; G06F 11/3409

(57) ABSTRACT

The present disclosure relates to a method for operating an Artificial-Intelligence Module (AI-Module). The AI-Module is trained to generate an output dependent on input usage data. The method may comprise providing the input usage data relating to a request requiring computing resources of a computer system. The method may further comprise approximating a computational demand for executing the AI-Module in order to generate the output. The method may further comprise approximating a benefit of using the AI-Module, wherein the benefit depends on an evaluation of a fulfilment of the request by the computer system in case being operated dependent on the output. The method may further comprise checking whether the computational demand exceeds the benefit. The method may further comprise disabling the executing of the AI-Module for generating the output in case the computational demand exceeds the benefit.

### BACKGROUND

The present invention relates to the field of digital computer systems, and more specifically, to a method for operating an Artificial-Intelligence Module and a computer system for operating an Artificial-Intelligence Module.

Usually, a workload of a mainframe computer may be managed by a work load management algorithm. The management of the workload may comprise scheduling submitted jobs to be executed by means of the computer system and setting up processes for controlling an execution of the jobs. It is known to use an Artificial-Intelligence Module for determining a number of processes for controlling the execution of the jobs, for example dependent on a current daytime.

### SUMMARY

In one aspect, a method is disclosed for operating an Artificial-Intelligence Module, AI-Module. The AI-Module is trained to generate an output dependent on input usage data. The method may comprise providing the input usage data relating to a request requiring computing resources of a computer system. The method may further comprise approximating a computational demand for executing the AI-Module in order to generate the output. The method may further comprise approximating a benefit of using the AI-Module, wherein the benefit depends on an evaluation of a fulfilment of the request by the computer system in case being operated dependent on the output. The method may further comprise checking whether the computational demand exceeds the benefit. The method may further comprise disabling the executing of the AI-Module for generating the output in case the computational demand exceeds the benefit.

In another aspect, a computer program product is disclosed comprising a computer-readable storage medium having computer-readable program code embodied therewith, the computer-readable program code being readable by a computing system to cause the computing system to perform the method of the above example.

In another aspect, a computer system is disclosed for operating an Artificial-Intelligence Module, AI-Module. The AI-Module is trained to generate an output dependent on input usage data. The computer system is configured to provide the input usage data relating to a request requiring computing resources of a computer system. The computer system is further configured to approximate a computational demand for executing the AI-Module in order to generate the output. The computer system is further configured to approximate a benefit of using the AI-Module, wherein the benefit depends on an evaluation of a fulfilment of the request by the computer system in case being operated dependent on the output. The computer system is further configured to check whether the computational demand exceeds the benefit. The computer system is further configured to disable the executing of the AI-Module for generating the output in case the computational demand exceeds the benefit.

The above summary is not intended to describe each illustrated embodiment or every implementation of the present disclosure.

### BRIEF DESCRIPTION OF THE DRAWINGS

In the following examples are explained in greater detail, by way of example only, making reference to the drawings in which:

FIG. 1 is a flowchart of a method for operating an AI-Module in accordance with an example of the present subject matter;

FIG. 2 illustrates a computer system for operating the AI-Module dependent on an input usage data and for approximating a benefit of the AI-Module and for disabling the AI-Module in case a computational demand for using the AI-Module exceeds the benefit;

FIG. 3 depicts a variant of the computer system according to FIG. 2 with a data storage for storing historical data about a past usage of the computer system;

FIG. 4 shows datasets of the historical data;

FIG. 5 depicts a variant of the computer system according to FIG. 2 with a second AI-Module for approximating the benefit of the AI-Module; and

FIG. 6 depicts a computing environment in accordance with an example of the present subject matter.

### DETAILED DESCRIPTION

Various examples provide a method for operating an Artificial-Intelligence Module, computer program product and computer system as described by the subject matter of the independent claims. Advantageous examples are described in the dependent claims. Examples of the present invention can be freely combined with each other if they are not mutually exclusive.

The descriptions of the various examples of the present disclosure will be presented for purposes of illustration but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

In one aspect, a method is disclosed for operating an Artificial-Intelligence Module, AI-Module. The AI-Module is trained to generate an output dependent on input usage data. The method may comprise providing the input usage data relating to a request requiring computing resources of a computer system. The method may further comprise approximating a computational demand for executing the AI-Module in order to generate the output. The method may further comprise approximating a benefit of using the AI-Module, wherein the benefit depends on an evaluation of a fulfilment of the request by the computer system in case being operated dependent on the output. The method may further comprise checking whether the computational demand exceeds the benefit. The method may further comprise disabling the executing of the AI-Module for generating the output in case the computational demand exceeds the benefit.

Thus, by reducing unnecessary computations in case the demand exceeds the benefit may lead to a lower energy consumption of the computer system. This may be advantageous especially in applications of the computer system with respect to large-scale deployments like cloud computing and in case the computer system is designed in the form of a mainframe computer. Disabling the inferencing in case the demand exceeds the benefit may also reduce the risk of overburdening the computer system, leading to more stable and predictable performance of the computer system.

Regarding the described method for operating an Artificial-Intelligence Module, AI-Module, the executing of the AI-Module for generating the output may also be referred to as inferencing of the AI-Module. The inferencing may comprise generating the output dependent on the input usage data using the AI-Module. Unless otherwise described, it is assumed that the AI-Module is trained. In this disclosure, the term computational demand may refer to a computational demand for performing the inferencing. Further, the phrase “disabling the inferencing” may be understood as stopping or interrupting the inferencing or disabling or turning off a component of the computer system which is configured to initiate the inferencing or restarting the inferencing. Further, the phrase “enabling the inferencing” may be understood as restarting inferencing or enabling or turning on the component of the computer system which is configured to initiate the inferencing or restarting the inferencing.

The disabling of the inferencing in case the computational demand exceeds the benefit may allow to save computational resources of the computer system in this case. The request requiring computing resources may be in the form of jobs, for example batch jobs, to be executed by the computer system. Thus, in one example, the request may be considered as a request for computing resources which may be used for executing the jobs on the computer system. The request for computing resources may be considered as a request for a first set of computing resources. The request for computing resources may comprise a request for providing a first set of processor-power of the computer system, for example providing a first set of processor cycles and/or a first set of processors of the computer system by means of the computer system and/or a request for providing a first set of memory of the computer system. A number of the first set of processors may be prescribed by a job script of the respective job. Thus, the first set of computing resources may comprise the first set of processor cycles provided by the computer system, the first set of processors and/or the first set of memory.

Fulfilling the request may imply providing the first set of computing resources for executing the submitted jobs. In one example, the computer system may fulfill the request by providing the first set of computing resources for executing the submitted jobs according to the request. The providing of the first set of computing resources may comprise providing the number of processor cycles and/or processors by means of the computer system prescribed by the job script of the respective job, and/or providing the memory of the computer system which may be requested according to the request.

The performing of the inferencing may involve using a second set of processors of the computer system dedicated to the inferencing, wherein the second set of processors may be used for fulfilling the request for computing resources, in one example for executing the jobs, in case the inferencing is disabled. The second set of processors may be considered as a part of a second set of computing resources. The second set of computing resources may comprise a second set of processor cycles executed by the second set of processors and, in one example a second set of memory of the computer system. The computational demand may be specified by the second set of computing resources, for example by the second set of processors and/or the second set of processor cycles.

Thus, the second set of computing resources, such as the second set of processors, may be available for fulfilling the request by disabling the inferencing. Hence, a performance of the computer system with respect to fulfilling the request may be enhanced by disabling the inferencing in case the computational demand exceeds the benefit as more computing resources, such as a part or all of the second set of computing resources, may be available for executing the jobs. That may provoke that the jobs may be completed faster. It is understood, that in most cases the first set of computing resources may not be available immediately. Generally, the first set of computing resources may be provided by the computer system over time. That time may be reduced by disabling the inferencing and by that providing the second set of computing resources for executing the jobs.

In one example, the computer system may be designed in form of a mainframe computer. The disabling of the inferencing in case the computational demand exceeds the benefit may be even more advantageous in case the computer system is designed in the form of the mainframe computer because the disabling may ensure to use efficiently the hardware resources in applications of the computer system with varying requests and high-demand scenarios without overloading the computer system. Hence, the disabling of the inferencing may enhance a reliability of the computer system.

In one example, the request may comprise the jobs to be executed by the computer system. The input usage data may comprise information about one or more of anything of the following: a total number of the jobs; a number of a respective subset of the jobs which are assigned to the respective service class; a current pattern of the jobs; an association of the jobs to the different service classes. The service classes may represent different computational requirements for an execution of the jobs by means of the computer system. The input usage data comprising detailed descriptions of the jobs, such as a total job count, job distribution across service classes, and the current pattern, may allow the AI-Module to generate the output in a manner which is more adapted to the descriptions of the jobs. This may allow to operate the computer system in a manner which is more adapted to the request as the computer system may be operated dependent on the output in case the AI-Module is enabled. This may increase the benefit of using the AI-Module in case the AI-Module is enabled.

In one example, the different computational requirements may relate to different performance goals, resource requirements and/or priority levels of the execution of the jobs. The different performance goals and resource requirements and/or priority levels of the service classes may allow to approximate the benefit more accurately in case the jobs are assigned to different service classes.

In one example, the approximating of the benefit may comprise determining a benefit score. The benefit score may represent the benefit in the form of a number. According to this example, the approximating of the computational demand may comprise determining a demand score. The demand score may represent the computational demand in the form of a further number. The computational demand exceeds the benefit in case the demand score is greater than the benefit score. As the benefit score and the demand score are numbers, the benefit score may be compared mathematically with the demand score. This may alleviate to judge whether the computational demand is greater than the benefit.

In one example, the request may specify the jobs to be executed by means of the computer system and the benefit may depend on a saving of total waiting time for the jobs to be completed by means of the computer system. The saving of total waiting time for the jobs to be completed may be considered as advantage in case the inferencing is enabled. Thus, the benefit depending on the saving of total waiting time may allow to perform an effective decision based on a check whether the computational demand is greater than the benefit.

In one example, the request may specify jobs to be executed by means of the computer system and the jobs may be assigned to different priority levels. According to this example, the benefit may depend on weighted savings of waiting times for the jobs to be completed by means of the computer system. The saving of the waiting time for the respective job may be weighted dependent on the priority level to which the respective job is assigned to. Weighting the savings of waiting times dependent on the priority level may enhance accuracy of the approximating of the benefit.

In one example, the computational demand for executing the AI-Module in order to generate the output may comprise a network utilization demand due to a usage of a network of the computer system which provides a communication link for a communication between the AI-Module and a requesting unit. The communication between the AI-Module and the requesting unit may comprise sending the input usage data from the requesting unit to the AI-Module and sending the output from the AI-Module to the requesting unit. Taking into account the network utilization demand may allow to approximate the computational demand more accurately and thereby may result in an overall reduction of power consumption, a reduction of latency due to network bandwidth consumption, and a reduction of the usage of hardware resources.

In one example, the AI-Module may be configured to generate the output dependent on the input usage data and historical data about past requests requiring computing resources of the computer system. Thus, the inferencing may comprise generating the output dependent on the input usage data and the historical data in this case. The computational demand may comprise a computational demand for performing computational steps for generating the output on the basis of the input usage data and the historical data. Generating the output on the basis of the input usage data and the historical data may enhance an accuracy of the output.

In one example, the computational demand for executing the AI-Module in order to generate the output may comprise a computational demand for transferring the historical data from a data storage to the AI-Module. The sending of the historical data from the data storage to the AI-Module may increase the number of the network request processor cycles. Thus, considering this demand may allow to approximate the computational demand more accurately.

In one example, the historical data about the past requests may comprise for the respective past request a respective value of a performance metric and information about whether the AI-Module was used for fulfilling the respective past request. The respective value of the performance metric may indicate an evaluation of fulfilment of the respective past request by the computer system. The approximating of the benefit may involve approximating the benefit on the basis of the historical data. In this case, the historical data may allow to compare the request with one or more of the past requests. Furthermore, the approximating of the benefit may take into account how the AI-Module fulfilled the respective past request dependent on the respective value of the performance metric. This may enable to approximate the benefit more accurately.

In one example, the historical data about the past requests may comprise information about one or more of anything of the following: a total number of past jobs submitted within past time intervals, a number of a respective subset of the past jobs which are assigned to a respective service class and/or historical patterns of the past jobs; an association of the past jobs to the different service classes. The service classes may represent different requirements for an execution of the past jobs by means of the computer system.

The respective historical pattern may comprise information about a temporal distribution of points of time of submissions of a respective set of the past jobs within the respective past time interval and/or sizes of the past jobs. The size of the respective past job may be indicated by a number of required processor cycles for executing the respective past job.

In one example, the AI-Module may be configured to generate the output dependent on the current pattern and the historical patterns. This may allow to generate the output of the AI-Module dependent on a similarity between the current pattern and one or more of the historical patterns. By that, the accuracy of the output may be increased.

In one example, the AI-Module may be configured to generate the output dependent on a similarity between the current pattern and the historical patterns.

In one example, the approximating of the benefit may comprise determining a pattern similarity score. The pattern similarity score may indicate a similarity between the current pattern and the historical patterns. The disabling of the executing of the AI-Module may be performed in case the pattern similarity score is less than a given first threshold. Using the similarity score may allow to perform an effective decision whether or not to disable the inferencing.

In one example, the input usage data may comprise information about a daytime, a weekday and/or a month at which the request is pending. According to this example, the approximating of the benefit may comprise predicting a future demand of computing resources of the computer system on the basis of the information about the daytime, the weekday and/or the month at which the request is pending using the historical data. The method may further comprise disabling the executing of the AI-Module for generating the output in case the predicted future demand is less than a given second threshold. According to this example, a usage of the AI-Module may not be beneficial in case the predicted future demand lies below the second threshold. Using the information about the daytime, the weekday and/or the month at which the request is pending together with the historical data may alleviate to recognize repeating patterns of jobs submitted to the computer system.

In one example, the request may comprise the jobs to be executed by the computer system. The computer system being operated dependent on the output may comprise setting a number of the initiator processes to be executed on the computer system dependent on the output. An executing of the initiator processes on the computer system may involve initiating an execution of the jobs. The evaluation of the fulfilment of the request by the computer system may depend on the number of the initiator processes to be executed. By setting the number of initiator processes based on the AI-generated output, the job execution may be managed more efficiently and delays of executing the jobs may be reduced. Furthermore, this may ensure that an appropriate number of initiator processes are set up to handle the jobs, thereby minimizing waiting times and optimizing system throughput. As a result, the evaluation of fulfilment of the request fulfillment may be performed more accurately.

In one example, the method may further comprise performing the disabling of the executing of the AI-Module for generating the output in case a current workload of the computer system is greater than a given third threshold. Disabling the inferencing in case the current workload is greater than the third threshold may allow to protect the computer system from overloading.

In one example, the method may further comprise performing the disabling of the executing of the AI-Module for generating the output in case a current workload of the computer system is less than a given fourth threshold. In case the current workload is less than the fourth threshold the benefit of the AI-Module may be too low. In case, an amount of the current workload may be used as a basis to decide whether to use the AI-Module or not. This may present quick and simple manner to decide whether the inferencing should be disabled or not.

Generally, the computer system may be configured to be operated dependent on the output in case the inferencing is not disabled. In case the inferencing is not disabled, i.e. is enabled, the AI-Module may determine the output dependent on the input usage data. The output may be considered as an indicator of an estimated amount of computing resources required to fulfill the request or may positively correlate with the indicator. The indicator may indicate a future workload of the computer system which is related to the request. In one example, the output may be a scalar value.

In one example, the computer system may be configured to generate the output repeatedly within a future time interval in case the inferencing is enabled. Thus, in each repetition an updated version of the output may be generated by the AI-Module in case the inferencing is enabled. In this case, the computational demand for executing the AI-Module in order to generate the output may be a sum of a computational demand for executing the AI-Module in order to generate each updated version of the output in each repetition in case the inferencing is enabled. The phrase “inferencing” according to the definition of the inferencing may comprise generating the output repeatedly. The input usage data may be updated in this case in each repetition.

The computer system being operated dependent on the output may involve setting a value of an operation parameter of the computer system dependent on the output and operating the computer system having the value of the operation parameter set dependent on the output. For example, the value of the operation parameter may be the number of initiator processes to be executed on the computer system. Alternatively, or in addition, one of the operation parameters may be a number of partitions the computer system may be divided into.

Performing the respective initiator process on the computer system may involve selecting a respective job of the jobs, assigning a respective set of processors and a respective part of the memory of the computer system to the selected job, initiating an execution of the selected job, managing input/output operations of the selected job, performing an error detection during the execution of the job and releasing the assigned respective set of processors and the respective part of the memory after the selected job is completed.

The computer system, in one example a workload manager of the computer system, may select a dedicated set of processors for performing the initiator processes, in the following also referred to as initiator processors. In one example, the workload manager may be configured to select the initiator processors and provoke the executing of the initiator processes on the initiator processors. In one example, the workload manager may be considered as an entity of the computing system for organizing computing resources of the computer system. For example, the workload manager may be configured to disable the inferencing in case the computational demand exceeds the benefit. As the initiator processors themselves may form a part of the processors of the computer system, an optimal number of the initiator processes running at the same time may vary according to the future workload of the computer system. The future workload may comprise future processes to be run on the computer system for executing the jobs in order to fulfill the request. Here, the AI-Module may provide a basis for determining an estimated optimal number of initiator processes in the form of the output.

In one example, the output may be equal to the estimated optimal number of initiator processes. Alternatively, the workload manager may be configured to determine the estimated optimal number of initiator processes dependent on the output. In this case, the output may be proportional to an expected delay of the fulfilment of the request. For example, the output may be a value indicating an estimated length of a queue on a respective partition of the computer system dedicated for a respective service class. In this case, the computer system may execute different sets of initiator processes for different service classes, wherein a service class is a named group of work within a workload with similar performance goals, resource requirements, or business importance. The workload manager may be configured to provoke an execution of a number of initiator processes which is equal to the estimated optimal number of initiator processes.

Enabling the inferencing may allow to set the computer system close to an optimal state, for example by setting the number of initiator processes dependent on the output, for fulfilling the request. This may potentially lead to a better fulfillment of the request compared to a case according to which the computer system is operated with the operation parameter set without using the output of the AI-Module. In one example, the benefit may be specified by a degree to which the request is fulfilled better in case the value of the operation parameter of the computer system is set dependent on the output compared to a case according to which the value of the operation parameter of the computer system is set without using the output.

Fulfilling the request better may involve achieving one or more of the below mentioned performance goals better. For example, in case the value of the operation parameter of the computer system is set dependent on the output one or more of the performance goals may be achieved; in case the value of the operation parameter of the computer system is set without using the output none of the performance goals may be achieved. This may be considered as an example according to which the request is fulfilled better in case the value of the operation parameter of the computer system is set dependent on the output compared to the case according to which the value of the operation parameter of the computer system is set without using the output. For fulfilling the request without using the AI-Module, the workload manager may, according to one example, determine the number of initiator processes without using the AI-Module, for example by using another algorithm.

However, as the enabling of the inferencing may involve occupying the part of the processors dedicated to the inferencing, there may be a possibility that a consumption of the resources of the request may not be as expected because the part of the processors dedicated to the inferencing cannot be used for executing the jobs. In addition, performing the inferencing and executing the jobs within the future time interval may increase a risk of overloading the computer system. This may lead to an unstable performance of the computer system. Such a situation may be prevented by disabling the inferencing in case the computational demand exceeds the benefit.

In case the computer system is designed in form of the mainframe computer, for example in the form of IBM's z/Architecture, the computer system may comprise specialized processors, featuring high GHz frequencies, hardware multithreading, and/or advanced caching for reliability and throughput. Furthermore, according to this example, the computer system may provide a processor communication on the basis of high-speed interconnects like zHyperLink (a low-latency data transfer technology) and memory architectures with ECC (Error-Correcting Code) and RAIM (Redundant Array of Independent Memory). In one example, the computer system may be configured to perform I/O (Input/Output) operations using protocols like FICON (Fiber Connectivity) and dedicated subsystems. In addition, the computer system may be designed to perform virtualization which may comprise hosting multiple independent operating systems and applications which may be considered as virtual machines, each functioning as though running on its own dedicated hardware. In one example, the computer system may be configured to perform the virtualization via Logical Partitions or LPARs. The computer system may be configured to create LPARs by partitioning hardware resources of the computer system like the processors, memory, and I/O channels of the computer system.

In most cases, the AI-Module may be configured to determine the output dependent on the input usage data and the historical data about the past requests requiring computing resources of the computer system. The past requests may be submitted within the past time intervals. The past time intervals may, according to one example, start an hour, a day, a week, or a month before a submission of the request is performed and may end at a point of time of a submission of the oldest job of the jobs of the request. The past requests may be in the form of the past jobs submitted within the past time intervals.

In one example, the respective service class may represent a respective set of computational requirements for an execution of the jobs which are associated to the respective service class by means of the computer system. The current pattern of the jobs may comprise information about a temporal distribution of points of time of submissions of the jobs and/or sizes of the jobs. The size of the respective job may be indicated by a number of required processor cycles for executing the respective job.

In one example, the computer system, for example the workload manager, may generate the input usage data dependent on information about the request. The information about the request may comprise user IDs specifying users which submitted the jobs, jobnames which may label the jobs, job IDs specifying the jobs and/or individual request IDs. The computer system, in one example the workload manager, may generate further information dependent on the information about the request. For example, the computer system, in one example the workload manager, may associate the respective service class to the respective job dependent on the information about the request. Such an association may be one example of the further information. The computer system, in one example the workload manager, may incorporate the further information into the input usage data. The computer system, in one example the workload manager, may derive the total number of the jobs, the number of the respective subset of the jobs which are assigned to the respective service class and/or the current pattern of the jobs on the basis of a monitoring of the jobs submitted to the computer system. By generating the input usage data, the computer system, in one example the workload manager, may be enabled to provide the input usage data to the AI-Module.

In one example, the performance goals may comprise one or more of anything of the following: an average waiting time of the jobs of the respective service class to be completely executed by the computer system being less than a prescribed average waiting time limit for the respective service class, a maximal waiting time of the jobs of the respective service class to be completely executed by the computer system being less than a prescribed maximal waiting time limit for the respective service class, a queue length of a queue of the jobs which are associated to the respective service class being less than a prescribed queue length limit for the respective service class. The waiting time of the respective job may start at a point of time of a submission of the respective job to the computer system and may end with a completion of the respective job.

Alternatively, or in addition, the performance goals may comprise an average time delay of the jobs of the respective service class being less than a prescribed average time delay limit for the respective service class. The time delay of the respective job may be a time span which starts from the point of time of the submission of the respective job and ends at a point of time when one of the initiator processes selects the respective job for the execution of the respective job.

Alternatively, or in addition, the performance goals may comprise a maximal time delay of the jobs of the respective service class being less than a prescribed maximal time delay limit for the respective service class.

Alternatively, or in addition, the performance goals may comprise an average interruption time of the jobs of the respective service class being less than a prescribed average interruption time limit for the respective service class. The interruption time of the respective job may be an accumulation of time spans in which the execution of the respective job which is interrupted after the respective job was selected by means of one of the initiator processes. In one example, the interruption time of the respective job may comprise a time span which starts at the point of time when one of the initiator processes selects the respective job for the execution of the respective job and ends at a point of time when the execution of the respective job starts. How often and how long the respective job may be interrupted may depend on the service class the respective job is associated to.

Alternatively, or in addition, the performance goals may comprise a maximal interruption time of the jobs of the respective service class being less than a prescribed maximal interruption time limit for the respective service class.

Alternatively, or in addition, the performance goals may comprise an average execution-interruption ratio of the jobs of the respective service class being greater than a prescribed average execution-interruption ratio limit for the respective service class. The execution-interruption ratio of the respective job may be equal to a quotient with a net execution time of the respective job as a dividend of the quotient and a sum of the net execution time of the respective job and the interruption time of the respective job as a divisor of the quotient.

Alternatively, or in addition, the performance goals may comprise a minimal execution-interruption ratio of the jobs of the respective service class being greater than a prescribed minimal execution-interruption ratio limit for the respective service class.

According to a simple example, a first service class may involve the jobs which require to be executed within a couple of milliseconds and a second class may involve the jobs which require to be executed within a couple of seconds. According to another example, the first service class may refer to a first type of jobs which may be allowed to only have a value of the execution-interruption ratio greater than a first minimal execution-interruption ratio limit and the second service class may refer to a second type of jobs which may be allowed to only have a value of the execution-interruption ratio greater than a second minimal execution-interruption ratio limit, wherein the first minimal execution-interruption ratio limit is greater than the second minimal execution-interruption ratio limit. According to these examples, the first service class may be assigned to a higher priority than the second service class. Thus, the jobs associated to the first service class may be assigned to a higher priority than the jobs associated to the second service class, according to these examples.

The respective priority level may represent a respective maximal waiting time for the jobs to be started on the computer system after submitting the jobs to the computer system, in the following referred to as a respective maximal latency. The higher the priority, the lower the maximal latency may be. Thus, in one example, the first service class may involve the jobs which are assigned to the lowest maximal latency. The lowest maximal latency may be equal to 30 minutes for example. The second service class may involve the jobs which are assigned to the greatest maximal latency. The greatest maximal latency may be equal to 2 days for example.

In the following, variants are described how the benefit of the using of the AI-Module, for example by using the output for setting the value of the operation parameter dependent on the output, may be approximated.

As the benefit depends on the evaluation of the fulfilment of the request by the computer system in case being operated dependent on the output, the approximating of the benefit may comprise determining the evaluation of the fulfilment of the request in case the inferencing is enabled and the value of the operation parameter is set dependent on the output and the computer system is operated dependent on the output, wherein this evaluation is in the following referred to as evaluation of the enabled inferencing.

According to a simple example, the computer system may set the benefit equal to the evaluation of the enabled inferencing or may calculate the benefit dependent on the evaluation of the enabled inferencing. Alternatively, the computer system may set the benefit equal to a difference between the evaluation of the enabled inferencing and an upper threshold for an evaluation of the fulfilment of the request in case the inferencing is disabled, and the value of the operation parameter is set independently from the output, wherein this evaluation is referred to in the following as evaluation of the disabled inferencing. The upper threshold for the evaluation of the disabled inferencing may be prescribed and may be, in one example, obtained through experiments before performing the approximating of the computational demand, the approximating of the benefit and the checking whether the computational demand exceeds the benefit.

According to another example, the computer system may set the benefit equal to a difference between the evaluation of the enabled inferencing and the evaluation of the disabled inferencing or may compute the benefit dependent on the difference. In this case, the approximating of the benefit may also comprise determining the evaluation of the disabled inferencing. According to this example, the benefit may directly indicate how much the computer system may fulfil the request better in case the inferencing is enabled compared to the case according to which the inferencing is disabled. In one example, the computer system may multiply the evaluation of the enabled inferencing or the difference with a first conversion factor to form the benefit. In one example, the benefit score may be the difference between the evaluation of the enabled inferencing and the evaluation of the disabled inferencing.

According to one example, the computer system may be configured to determine the evaluation of the enabled inferencing by estimating a probability of achieving one or more of the performance goals in case the inferencing is enabled. Analogously, the computer system may be configured to determine the evaluation of the disabled inferencing by estimating a probability of achieving one or more of the performance goals in case the inferencing is disabled.

For example, the computer system may estimate a probability for the respective service class that the average waiting time of the jobs of the respective service class lies below the prescribed average waiting time limit for the respective service class in case the inferencing is enabled. In one example, the computer system may weight the estimated probabilities for the service classes for the enabled inferencing with the priority level of the respective service class, wherein a high value of the priority level indicates a high priority. The computer system may add the weighted estimated probabilities to form an estimated overall probability score for the enabled inferencing.

The estimated overall probability score for the enabled inferencing may represent a weighted probability for achieving the performance goal that the average waiting time of the jobs lies below the prescribed average waiting time limit for the respective service class in case the inferencing is enabled. In one example, the computer system may set the evaluation of the enabled inferencing equal to the estimated overall probability score for the enabled inferencing or determine the evaluation of the enabled inferencing dependent on the estimated overall probability score for the enabled inferencing, for example by multiplying the estimated overall probability score for the enabled inferencing with a second conversion factor.

Analogously, the computer system may estimate a probability for the respective service class that the average waiting time of the jobs of the respective service class lies below the prescribed average waiting time limit for the respective service class in case the inferencing is disabled, in the following referred to as estimated probability for the disabled inferencing. In one example, the computer system may weight the estimated probabilities for the disabled inferencing with the priority level of the respective service class, wherein a high value of the priority level indicates a high priority. The computer system may add the weighted estimated probabilities for the disabled inferencing to form an estimated overall probability score for the disabled inferencing.

The estimated overall probability score for the disabled inferencing may represent a weighted probability for achieving the performance goal that the average waiting time of the jobs lies below the prescribed average waiting time limit for the respective service class in case the inferencing is disabled. In one example, the computer system may set the evaluation of the disabled inferencing equal to the estimated overall probability score for the disabled inferencing or determine the evaluation of the disabled inferencing dependent on the estimated overall probability score for the disabled inferencing, for example by multiplying the estimated overall probability score for the disabled inferencing with a third conversion factor.

The saving of the total waiting time may be a difference between a total waiting time for the jobs to be completed by means of the computer system in case the inferencing is enabled, in the following referred to as total waiting time for the enabled inferencing, and a total waiting time for the jobs to be completed by means of the computer system in case the inferencing is disabled, in the following referred to as total waiting time for the disabled inferencing. In one example, the benefit may be equal to the saving of the total waiting time. According to this example, the evaluation of the enabled inferencing may be equal or may depend on the total waiting time for the enabled inferencing.

The computer system may be configured to approximate the total waiting time for the enabled inferencing and the total waiting time for the disabled inferencing dependent on the input usage data or dependent on the input usage data and the historical data. In one example, the benefit score may be equal to the saving of the total waiting time multiplied with a fourth conversion factor.

Considering the saving of the total waiting time for the jobs for determining the evaluation of the enabled inferencing may represent an efficient measure to determine the benefit as estimating the total waiting times may be considered as computationally cheap. As reducing the total waiting time for the jobs may be regarded as a performance goal, this may also be an effective measure in order to enhance the performance of the computer system.

Depending on the application example, the first, second, third or fourth conversion factor may allow to scale the evaluation of the enabled inferencing, the evaluation of the disabled inferencing or the difference to form the benefit such that the benefit may have a similar dimension as the computational demand in order to compare the benefit with the computational demand.

The saving of the waiting time of the respective job may be a respective difference between a waiting time for the respective job to be completed by means of the computer system in case the inferencing is enabled, in the following referred to as respective waiting time for the enabled inferencing, and a waiting time for the respective job to be completed by means of the computer system in case the inferencing is disabled, in the following referred to as respective waiting time for the disabled inferencing. The computer system may be configured to approximate the respective waiting time for the enabled inferencing and the respective waiting time for the disabled inferencing dependent on the input usage data or dependent on the input usage data and the historical data.

In one example, the computer system may multiply the saving of the waiting time of the respective job with the priority level to which the respective job is assigned for performing a weighting of the saving of the waiting time for the respective job. The benefit, in one example the benefit score, may be equal to a sum of the weighted savings of the jobs. Considering the weighted savings may allow to account for a prioritization of the jobs and the savings of the waiting times of the jobs at the same time. Thus, this approach may allow to approximate the benefit with a higher accuracy as, in general, a saving of the waiting time of a job with a higher priority level may provoke a higher benefit.

In one example, the requesting unit may be the workload manager. In one example, the computer system may execute the AI-Module on a first LPAR of the computer system and the requesting unit on a second LPAR of the computer system. In one example, the data storage may be provided by a third LPAR of the computer system.

In case the AI-Module and the requesting unit are run on the LPARs and data packets are sent between the AI-Module and the requesting unit, the network may be a virtual network simulated by the computer system. In this case, network utilization demand may comprise a demand for executing processor cycles for simulating the virtual network, in the following referred to as network request processor cycles. A number of the network request processor cycles may increase due to a memory bandwidth usage and/or a hypervisor overhead for managing data transfers. Additional network utilization demand may involve energy consumption, latency due to network stack processing, and potential throttling from Quality of Service (QoS) mechanisms.

The computer system may be configured to estimate the number of the network request processor cycles on the basis of the input usage data and a size of the AI-Module, for example a size of an input layer of the AI-Module. Considering the network utilization demand for approximating the computational demand may allow to account for not only computational demand for a performing of the inferencing itself but also for the demand of computations which are required to initiate the inferencing, such as sending the input usage data to the AI-Module, and to use output, such as sending the output to the requesting unit.

Generally, in case the AI-Module and the requesting unit are run on two separate physical machines of the computer system, the network utilization demand may involve a demand due to bandwidth consumption, hardware resource usage (e.g., Network Interface Card (NIC), switches, and routers), protocol overheads (e.g., Transmission Control Protocol/Internet Protocol (TCP/IP)). Furthermore, the network utilization demand may comprise a demand due to security measures like encryption (e.g., Secure Sockets Layer/Transport Layer Security (SSL/TLS)), power consumption by network devices.

In case the AI-Module may be configured to generate the output dependent only on the input usage data, the computational demand may comprise a computational demand for performing computational steps for generating the output on the basis of the input usage data. Generally, generating the output dependent not only of the input usage data but also dependent on the historical data may increase the accuracy of the output. In one example, the historical data may be in the form of a time series. The time series may comprise a respective dataset for the respective past time interval in which the respective set of the past jobs were submitted.

The AI-Module may be configured to determine the output dependent on the input usage data, in one example dependent on the time series and the input usage data. For that purpose, the AI-Module may comprise one or more RNNs (Recurrent Neural Networks), LSTM (Long Short-Term Memory), artificial neural networks Ann, TCNs (Temporal Convolutional Networks) and/or Transformer-based networks or another type of neural network or AI-modules based on classical machine learning, reinforcement learning or other algorithms which may be configured to process the input data for generating the output.

Considering the demand of the computational steps for generating the output on the basis of the input usage data or on the basis of the input usage data and the historical data, in the following referred to as inferencing demand, may allow to approximate the computational demand more accurately. The computational steps for generating the output on the basis of the input usage data or on the basis of the input usage data and the historical data may comprise computing output values of input neurons of the AI-Module dependent on the input usage data or dependent on the input usage data and the historical data, computing further output values of hidden neurons of the AI-Module dependent on the output values of the input neurons and computing the output dependent on the further output values.

Generally, the computer system may execute processor cycles for performing the inferencing, in the following referred to as inferencing processor cycles. In one example, the inferencing demand may be specified in the form of a number of the inferencing processor cycles for generating the output in the future time interval. In one example, the inferencing demand may comprise generating the updated versions of the output in case the AI-Module is configured to generate the output repeatedly and in case the inferencing is enabled.

In one example, the respective dataset may comprise information about the past jobs submitted within the respective past time interval, in the following referred to as respective past time interval information. In one example, the respective past time interval information may comprise for the respective past job submitted within the respective past time interval: information about the point of time of a submission of the past job, a waiting time of the past job to be completed by means of the computer system, the respective service class the respective past job is assigned to and a size of the respective past job. The size of the respective past job may be specified by the number of required processor cycles for executing the respective past job.

In another example, the respective past time interval information may be designed in a compressed form. In one example, the computer system may be configured to generate the compressed form of the respective past time interval information. For example, the computer system may be designed to use the respective past time interval information as an input and an output dataset of an auto-encoder in order to train the auto-encoder.

The computer system may be configured to obtain the compressed form of the respective past time interval information by reading out data of a middle layer of the auto-encoder which may comprise less neurons than an input layer of the auto-encoder for reading in the input dataset and less neurons than an output layer of the trained auto-encoder. The computer system may obtain the compressed respective past time interval information in response to inputting the respective past time interval information in the input layer of the trained auto-encoder.

The respective past time interval information may present an example of the respective historical pattern. The compressed respective past time interval information may present an example of a compressed version of the respective historical pattern. The information about the temporal distribution of points of time of submissions of the respective set of the past jobs and/or their sizes may be incorporated in the respective compressed past time interval information in a compressed form in this case. This may be regarded as an example according to which the historical patterns are designed in the form of compressed information about the past requests. The training of the auto-encoder may be considered as an example for learning the historical patterns.

Generally, compressing the respective past time interval information may allow to reduce a number of input channels of the AI-Module and may therefore reduce the computational demand for the inferencing.

The value of the performance metric may indicate to which degree one or more of the performance goals were achieved either in case the AI-Module was used for fulfilling the respective past request or in case the AI-Module was not used for fulfilling the respective past request. Thus, based on the historical data the benefit may be estimated.

In one example, the computer system may comprise a further trained AI-Module. The computer system may be configured to train the further AI-Module by using the respective past time interval information for an input dataset of the further AI-Module and the respective value of the performance metric as an output dataset of the further AI-Module. Alternatively, the computer system may be configured to train the further AI-Module by using the respective compressed past time interval information for the input dataset of the further AI-Module and the respective value of the performance metric as an output dataset of the further AI-Module. The respective input dataset may comprise information whether the AI-Module was used for fulfilling the respective past request.

In one example, the computer system may approximate the value of the performance metric by inputting information whether the inferencing is supposed to be disabled or enabled in the future time interval, the input usage data, the current pattern and/or a compressed version of the current pattern into the trained further AI-Module and receiving an approximated value of the performance metric as a result from the further AI-Module. Using the further AI-Module for approximating the value of the performance metric may allow to approximate the benefit in an easy manner for a user of the computer system as the further AI-Module may be regarded as a black-box. In addition, the historical data may be fully considered for the approximating of the benefit in case the further AI-Module is used.

In case the pattern similarity score is less than the given first threshold this may imply that the current pattern may not be recognizable by means of the AI-Module or that there is no current pattern at all or that the current pattern comprises a data drift compared to the historical patterns. In these cases, the accuracy of the output may be too low in order to use the output effectively for setting the value of the operation parameter of the computer system. As a result, the approximated benefit would be too low in this case.

The historical data may be used to perform an extrapolation of a historical knowledge which may be incorporated in the historical data. A result of the extrapolation may be the predicted future demand. To realize this, the computer system, in one example the AI-Module, may be configured to use a time series model, wherein the respective past time interval information may provide information about the respective past time interval and the information about the daytime, the weekday and/or the month at which the request is pending is used for performing the extrapolation.

The current workload may comprise a totality of all processes which are executed on the computer system, in the following referred to as current processes. In order to ensure a stable execution of important processes running on the computer system, such as for example processes with respect to protecting the security of the computer system, the inferencing may be disabled in case the current workload exceeds the third threshold. The third threshold may be specified by a usage of 95 percent of the processors of the computer system due to an execution of the current processes in one example. Alternatively, the third threshold may be specified by a usage of 95 percent of the LPARs of the computer system due to the execution of the current processes. The usage of the processors of the computer system may be considered as a system utilization of the computer system.

In case the current workload is less than the fourth threshold the benefit of the AI-Module may be too low. For example, the workload manager may not need support from the AI-Module for determining the number of initiator processes in this case as a determining of the number of initiators on the basis of the current workload may be sufficient in order to prevent long queues of the jobs. The fourth threshold may be specified by a usage of 25 percent of the processors of the computer system due to an execution of the current processes in one example. Alternatively, the fourth threshold may be specified by a usage of 25 percent of the LPARs of the computer system due to the execution of the current processes.

In one example, the computer system may be configured to use a respective AI-Module assigned to the respective service class for determining a respective number of initiators for the respective service class. In this case the computer system may be designed to perform a disabling of the respective AI-Module in case a workload assigned to the respective service class is less than a respective workload limit assigned to the respective service class. Alternatively, or in addition, the computer system may be designed to perform the disabling of the respective AI-Module in case there is no workload pattern detectable for the respective service class.

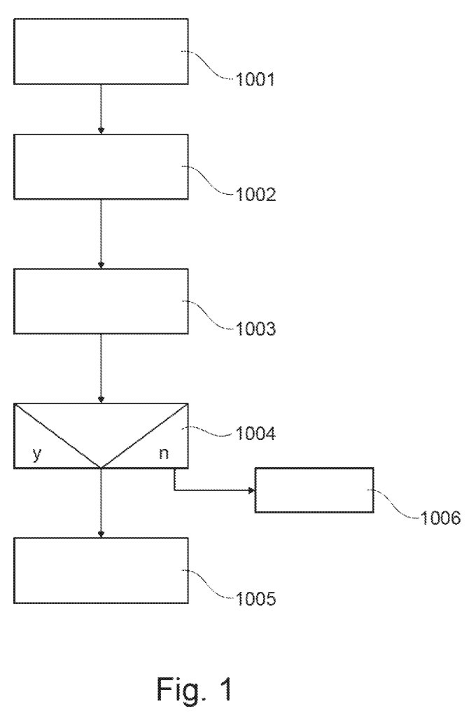

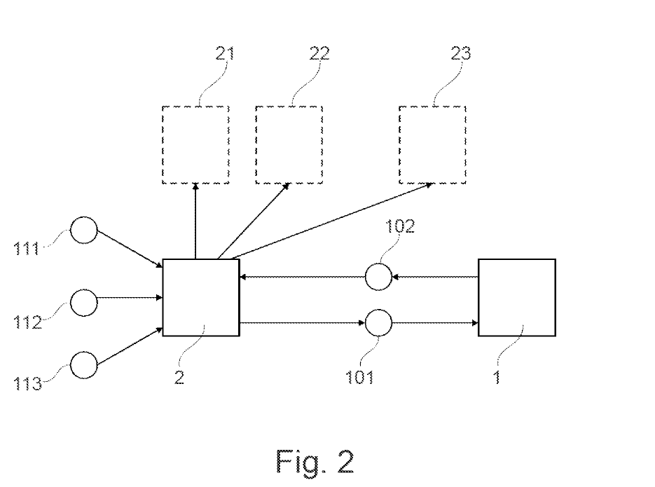

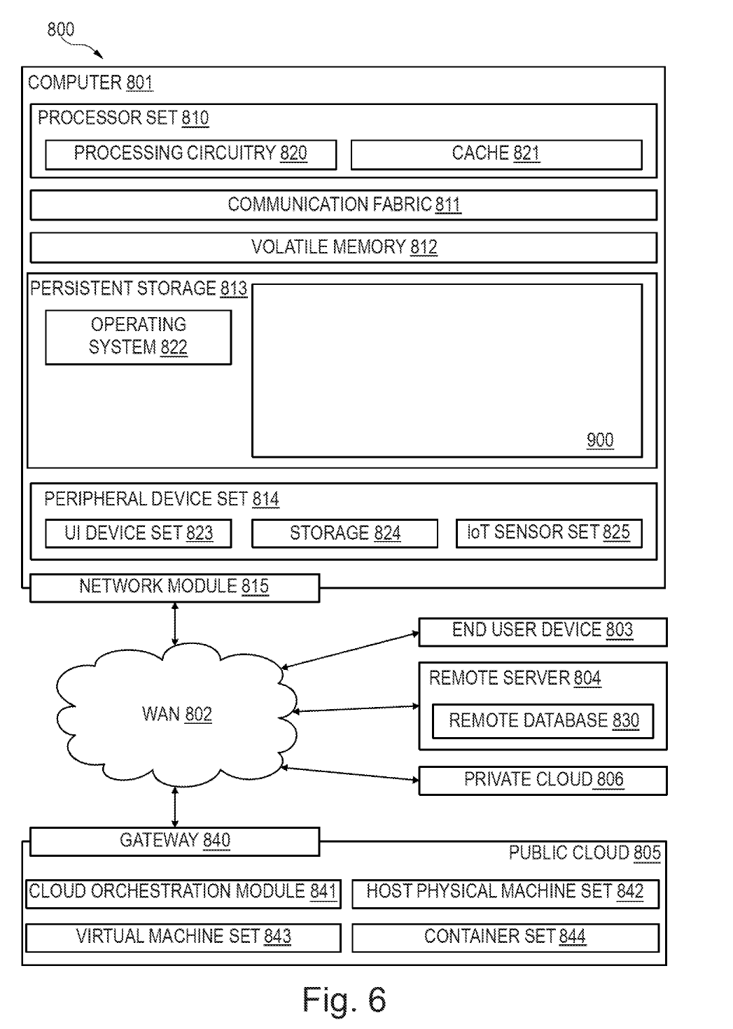

FIG. 1 is a flowchart of a method for operating an Artificial-Intelligence Module 1 (AI-Module 1), as shown in FIG. 2, in accordance with an example of the present subject matter. The AI-Module 1 may be considered as an example of the AI-Module. The AI-Module 1 is trained to generate an output 102 dependent on input usage data 101. For the purpose of explanation, the method described in FIG. 1 may be implemented in the computing environment 800 illustrated in FIG. 6 but is not limited to this implementation.

The method may comprise the following. A processor set 810 of a computer 801 shown in FIG. 6 may be configured to perform the steps in the form of operational steps.

In step 1001, the input usage data 101 may be provided. The input usage data 101 may relate to the request requiring computing resources of a computer system. The computer system may be the computer system, and may be represented by the computing environment 800 according to one example. In one example, the computing environment 800 may be designed in the form of the mainframe. The computer system may be set up to execute the AI-Module 1 on the first LPAR.

In one example as depicted in FIG. 2, a workload manager module 2 may receive a part of the input usage data 101 in the form of several individual requests, for example a first request 111, a second request 112 and a third request 113. The workload manager module 2 may present an example of an implementation of the workload manager. The computer system may be set up to execute the workload manager module 2 on the second LPAR, as described above. According to a variant, the computer system may be configured to execute the AI-Module 1 and the workload manager module 2 on the same LPAR, for example the first or the second LPAR.

In one example, the workload manager module 2 may combine, for example concatenate, the individual requests to a joint request. The joint request may present an example for the input usage data 101 or may serve as a basis for determining the input usage data 101. In addition, the joint request may serve as an example of the request.

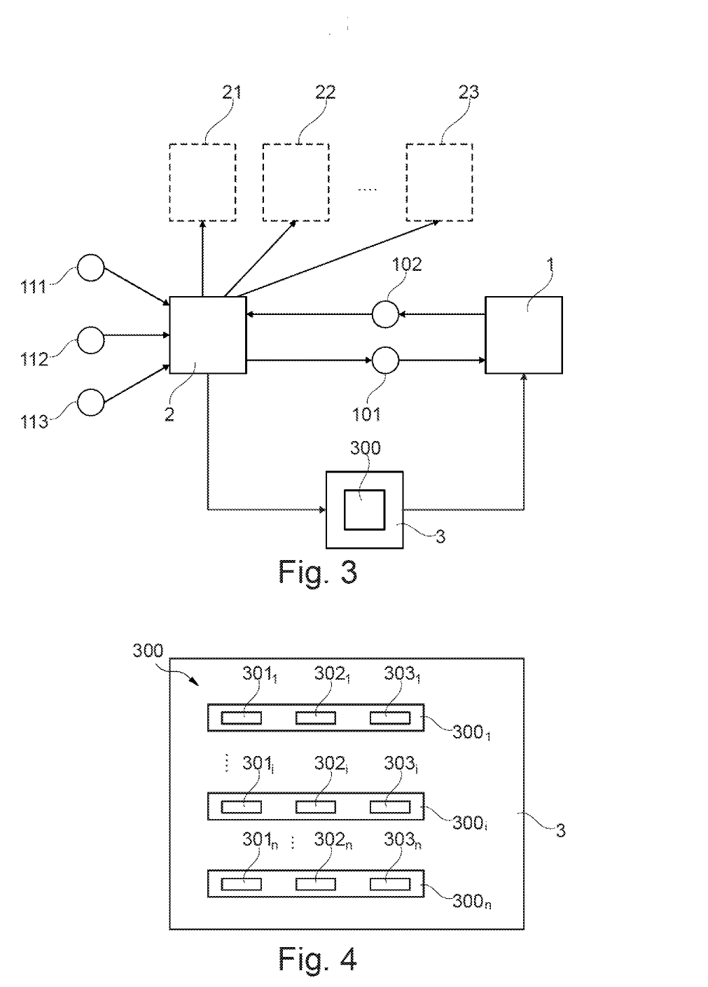

In step 1002, a computational demand for executing the AI-module 1 in order to generate the output 102 may be approximated. In one example, the workload manager module 2 may approximate the computational demand dependent on the network utilization demand and the inferencing demand. In one example, the workload manager module 2 may set the computational demand equal to a sum of the number of the network request processor cycles and the number of the inferencing processor cycles. The workload manager module 2 may approximate the inferencing processor cycles dependent on a number of the computational steps for generating the output 102 on the basis of the input usage data 101 or on the basis of the input usage data 101 and historical data 300, as depicted in FIG. 3. The historical data 300 may represent an example of the historical data.

In step 1003, the benefit of using the AI-module 1 may be approximated. The benefit depends on the evaluation of the fulfilment of the request by the computer system in case being operated dependent on the output 102. In one example, the workload manager module 2 may approximate the benefit according to one of the mentioned variants, for example by setting the benefit equal to the difference between the evaluation of the enabled inferencing and the evaluation of the disabled inferencing. To realize this, the workload manager module 2 may be configured to estimate the probability of achieving one or more of the performance goals in case the inferencing is enabled, in the following referred to as probability of the enabled inferencing. In addition, the workload manager module 2 may be configured to estimate a probability of achieving one or more of the performance goals in case the inferencing is disabled, in the following referred to as probability of the disabled inferencing. According to one example, the benefit may be set equal to the difference between the probability of the enabled inferencing and the probability of the disabled inferencing.

In step 1004, the computer system, for example the workload manager module 2, may check whether the computational demand exceeds the benefit. In one example, the workload manager module 2 may perform a mathematical comparison between the computational demand and the benefit. The benefit may be computed by performing one of the multiplications using one of the conversion factors, such as the first, second, third or fourth conversion factors, in order to yield a dimension for the benefit to perform the mathematical comparison.

In step 1005, the executing of the AI-module 1 for generating the output 102, i.e. the inferencing, may be disabled in case the computational demand exceeds the benefit. In one example, workload manager module 2 may disable the inferencing in case the computational demand exceeds the benefit. In case the computational demand is equal to the benefit or is less than the benefit, the workload manager module 2 may provoke a continuation of the executing of the AI-module 1 for generating the output 102 dependent on the usage data 101.

In most applications, the workload manager module 2 may send an updated version of the input usage data 101 to the AI-Module 1 repeatedly in consecutive time intervals, for example every 10 seconds, and may receive in response repeatedly an updated version of the output 102 in case the inferencing is enabled. It may be a common application of the computer system that the computer system receives new requests requiring computing resources of the computer system repeatedly. Thus, the joint request, i.e. the request may be updated in response to receiving the new requests and in doing so the input usage data 101 may be updated. In one example, the AI-Module 1 may be configured to generate the output 102 in response to receiving the input usage data 101. In this case, the inferencing may be disabled by stopping or interrupting a sending of the input usage data 101 to the AI-Module 1, or more precisely by stopping or interrupting a sending of an updated version of the input usage data 101 to the AI-Module 1. Such an interruption may persist a prescribed time span, for example 1 minute, 10 minutes or one hour. After the time span has elapsed, the computer system, for example the workload manager module 2, may perform a repetition of the steps 1001, 1002, 1003, 1004, and 1005. In one example, the AI-Module 1 may be retrained during the time span of the disabling of the AI-Module 1. Thus, the checking whether the computational demand exceeds the benefit may be considered as determining an optimal timing for retraining the AI-Module 1. Hence, in one example, the computer system may initiate the retraining of the AI-Module 1 in response to disabling the inferencing.

The first request 111, the second request 112 and the third request 113 as shown in FIG. 2 and 3 may be an example of individual requests requiring each a respective set of computing resources, for example a first set of processors, a second set of processors and third set of processors of the computer system respectively. The individual requests 111, 112, 113 may be considered as one example to specify the jobs to be executed on the computer system. The individual requests may be submitted in the form of job scripts. Client servers, not shown in the figures, may submit the individual requests 111, 112, 113 by sending the job scripts to the computer system. The workload manager module 2 may receive the individual requests 111, 112, 113 in response to sending the job scripts to the computer system. The job scripts may comprise metadata, such as a respective user ID of a user which submits the respective individual request, a respective job ID or individual request ID, and/or a respective job name. In one example, the workload manager module 2 may be configured to assign a respective service class to the job or the jobs of the respective individual request dependent on the metadata of the jobs. Thus, in one example, the workload manager module 2 may derive the number of the respective subset of the jobs which are assigned to the respective service class dependent on the individual requests. Generally, the computer system, in one example the workload manager module 2, may be configured to generate the input usage data 101 dependent on the individual requests, such as the individual requests 111, 112, 113. For example, information about the respective service class to which the respective job is assigned to may be incorporated into the input usage data 101, for example by means of the workload manager module 2.

A first service class 21 may represent critical jobs, such as jobs for performing a surveillance or a protection of the computer system. A second service class 22 may represent a first part of the jobs of the individual requests 111, 112, 113 comprising a high priority, in following referred to as high priority jobs. A third service class 23 may represent a second part of the jobs of the individual requests 111, 112, 113 comprising a low priority, in the following referred to as low priority jobs. In one example, the high priority jobs may be jobs for analyzing a behavior of a machine or a machine park or a power plant. Executing the high priority jobs may involve determining a current value of a state variable of the protection of the computer system, the machine, the machine park, or the power plant, such as a temperature of a part of the machine, the machine park, or the power plant, dependent on sensor values generated by sensors of the machine, the machine park, or the power plant. The low priority jobs may involve performing update processes of the computer system, for example.

In one example, workload manager module 2 may provoke the execution of the initiator processes. The initiator processes may select the jobs of the individual requests 111, 112, 113 according to the assigned service class of the jobs, initiate the selected jobs and may manage input/output operations of the selected jobs.

The workload manager module 2 may determine the number of initiator processes dependent on the output 102 in case the inferencing is enabled. In one example, the workload manager module 2 may initiate the execution of the initiator processes in advance in case the inferencing is enabled. This may reduce the risk that queues of waiting jobs are built on the computer system. The queues may increase the waiting times of the jobs to be completed. This may provoke that one or more of the performance goals are not met by the computer system. However, as the performing of the inferencing provokes the inferencing demand it may be possible that the computational demand may exceed the benefit. In this case, the workload manager module 2 may disable the inferencing, for example by interrupting the sending of the input usage data 101 to the AI-module 1.

FIG. 3 depicts a variant of the computer system shown in FIG. 2 according to which the computer system comprises a data storage 3. The data storage 3 may store historical data 300. In one example, the computer system may be set up to execute the data storage 3 on a third LPAR. In another example, the data storage 3 may be executed on the LPAR on which the AI-Module 1 is executed. The historical data 300 may be an example of the historical data about the past requests. The past requests may be in the form of the past jobs to be executed by means of the computer system which were submitted within the past time intervals. In one example, the AI-module 1 may be configured to generate the output 102 dependent on the input data 101 and the historical data 300.

FIG. 4 depicts an example of the historical data 300 according to which the historical data 300 may comprise a number of “n” historical datasets. FIG. 4 shows exemplarily a first historical dataset 300₁, an i-th historical dataset 300ᵢ, and an n-th historical dataset 300ₙ of the historical datasets. The respective historical dataset, which may be referred to as the i-th historical dataset 300ᵢ in FIG. 4, may be associated to the respective past time interval. The past time intervals may, for example, have each a length of one hour, a couple of hours, or one day depending on the application case. The respective historical dataset 300i may comprise request data 301ᵢabout the past jobs submitted within the respective past time interval. The respective request data 301ᵢmay comprise the respective past time interval information.

According to one variant, the respective historical dataset 300ᵢ may further comprise information about whether the AI-Module 1 was enabled or disabled during the respective past time interval, for example in the form of a respective AI-Module flag 302ᵢ. The AI-Module flag 302ᵢ may be set equal to zero in case the AI-Module 1 was disabled within the respective past time interval and may be set equal to one in case the AI-Module 1 was enabled within the respective past time interval.

In addition, the respective historical dataset 300ᵢ may further comprise a respective value of the performance metric 303ᵢ indicating the evaluation of fulfilment of the respective past request by the computer system within the respective past time interval. The evaluation of the fulfilment of the respective past request may depend on to which degree one or more of the performance goals were met within the respective past time interval. The first historical dataset 300₁and the n-th historical dataset 300ₙ may analogously respectively comprise request data 301₁, request data 301ₙ, an AI-Module flag 302₁, an AI-Module flag 302ₙ and a value of the performance metric 303₁and a value of the performance metric 303ₙ.

In one example, the respective value of the performance metric 303ᵢmay be obtained dependent on a deviation of a performance of the computer system during the respective past time interval from a selected performance goal. The selected performance goal may be one of the performance goals, for example an average waiting time of the past jobs of the respective service class to be completely executed by the computer system being less than the prescribed average waiting time limit for the respective service class, a maximal waiting time of the past jobs of the respective service class to be completely executed by the computer system being less than the prescribed maximal waiting time limit for the respective service class, a queue length of a queue of the past jobs which are associated to the respective service class being less than the prescribed queue length limit for the respective service class. The average and maximal waiting time may start at a point of time of a submission of the respective past job to the computer system and may end with completion of the respective past job.

According to one example, the computer system may be configured to determine the respective value of the performance metric 303ᵢautomatically. Alternatively, the respective value of the performance metric 303ᵢmay be determined manually, for example by a user of the computer system. The computer system may be configured to generate the respective historical dataset 300ᵢ after the end of the respective past time interval.

In one example, the respective historical dataset 300ᵢmay further comprise a past output which was generated by the AI-Module 1 for the respective past time interval in case the AI-Module 1 was enabled during the respective past time interval. The past output may be generated analogously to the output 102, however instead of inputting the input usage data 101 into the AI-Module 1, a past input usage data may be inputted. The past input usage data may relate to the past requests in a similar manner as the input usage data 101 relates to the request. The past input usage data may be comprised by the historical data 300. In this case, the historical data 300 may be used to retrain the AI-Module 1. In one example, the historical datasets may be sorted according to their value of the performance metric 303ᵢ. A subset of the historical datasets may be selected comprising the historical datasets having a value of the performance metric 303ᵢ being greater than a given performance threshold and having their AI-Module flag 302ᵢset equal to one, in the following referred to as training subset. The respective request data 301ᵢ of the training subset, for example the respective past time interval information, may be used as an input training dataset and the output of the training subset which was generated by the AI-Module 1 for the respective past time interval may be used as an output training dataset, or as a target value, for a retraining of the AI-Module 1. The retraining may be performed similar to a state of the art training using common machine learning techniques, for example backpropagation. The AI-Module 1 being retrained on the basis of the historical data may be configured to generate the output 102 dependent on the current pattern and the historical patterns, and in particular dependent on a similarity between the current pattern and the historical patterns.

In one example, the historical data 300 may be used for estimating the benefit. In this case, the computer system, for example the workload manager module 2, may compare the input usage data 101 with the request data of a first subset of the historical datasets having their AI-Module flag 302ᵢ set equal to one and may as a result select the most similar historical dataset from the first subset.

Furthermore, the computer system, for example the workload manager module 2, may compare the input usage data 101 with the request data of a second subset of the historical datasets having their AI-Module flag 302i set equal to zero and may as a result select the most similar historical dataset from the second subset. According to this example, the benefit may be set equal to a difference between the value of the performance metric of the most similar historical dataset of the first subset and the value of the performance metric of the most similar historical dataset of the second subset.

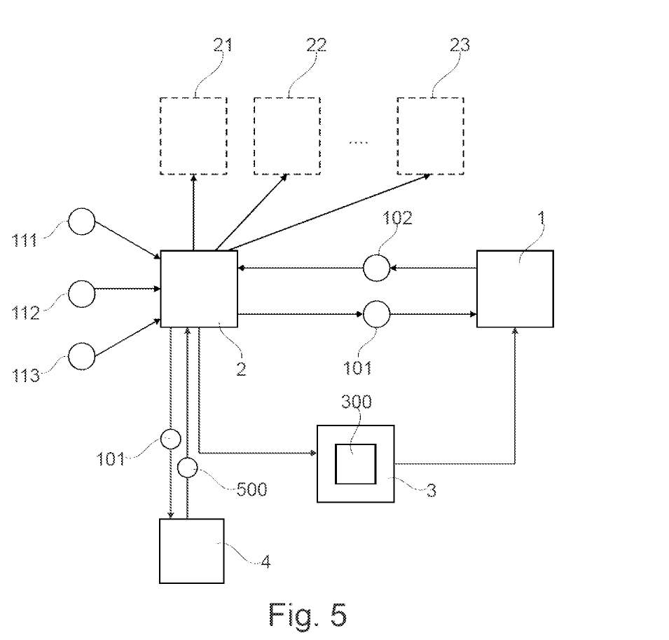

As shown in FIG. 5, the computer system may comprise a second AI-Module 4 for approximating the value of the performance metric. The second AI-Module 4 may be an example of the further AI-Module and may be trained as described on the basis of the historical data 300. When performing the training of the second AI-Module 4, the computer system may take into account whether the AI-Module flag 302ᵢ of respective historical dataset 300i is set equal to zero or to one. The value of the AI-Module flag 302ᵢmay be used as one of several inputs of the second AI-Module 4 during the training of the second AI-Module 4. The trained second AI-Module 4 may be configured to generate an approximated value 500 of the performance metric dependent on the input usage data 101.

During a usage of the trained second AI-Module 4, a first approximated value 500 of the performance metric may be computed dependent on the input usage data 101 having an AI-Module flag of the second AI-Module 4 set equal to one. The first approximated value 500 of the performance metric may be considered as an approximation of the value of the performance metric of the most similar historical dataset of the first subset of the historical datasets. Similarly, a second approximated value 500 of the performance metric may be computed dependent on the input usage data 101 having the AI-Module flag of the second AI-Module 4 set equal to zero. The second approximated value 500 of the performance metric may be considered as an approximation of the value of the performance metric of the most similar historical dataset of the second subset of the historical datasets.

In one example, the computer system may be set up to execute the second AI-Module 4 on a fourth LPAR or on the LPAR on which the AI-Module 1 is executed. The second AI-Module 4 may be used for selecting the most similar historical dataset of the first subset.

The term “module” as used herein refers to any known or in the future developed hardware, software such as an executable program, artificial intelligence, fuzzy-logic, or combination hereof for performing a function associated with the “module” or being a result of having performed the function associated with the “module”. For example, in a computing environment 800 as depicted in FIG. 6, code 900 may comprise an AI-module program and a workload manager program as an example of an implementation of the AI-Module 1 and the workload manager module 2 on the computer system. The computer system, for example the processor set 810, may execute functions which are associated with the AI-module 1 and/or the workload manager module 2 when processing the instructions of the AI-module program or the workload manager program. The respective function associated with the AI-module 1 and the workload manager module 2 may be described with the introductory phrase “… the AI-module 1 or the workload manager module 2 is configured to…”.

Computing environment 800 contains an example of an environment for the execution of at least some of the computer code involved in performing the inventive methods, such as code 900 for operating an AI-Module according to one of the described variants. The computing environment 800 may be one example of the computer system. In addition to block 900, computing environment 800 includes, for example, computer 801, wide area network (WAN) 802, end user device (EUD) 803, remote server 804, public cloud 805, and private cloud 806. In this example, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 6. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer-readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”), for example a method for operating an AI-Module according to one of the variants mentioned. These computer-readable program instructions are stored in various types of computer-readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various examples, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some examples, storage 824 may take the form of a quantum computing storage device for storing data in the form of qubits. In examples where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some examples, network control functions and network forwarding functions of network module 815 are performed on the same physical hardware device. In other examples (for example, examples that utilize software-defined networking (SDN)), the control functions and the forwarding functions of network module 815 are performed on physically separate devices, such that the control functions manage several different network hardware devices. Computer-readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some examples, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some examples, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines of the public cloud 805 from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other examples a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 805 and private cloud 806 are both part of a larger hybrid cloud.

CLOUD COMPUTING SERVICES AND/OR MICROSERVICES (not separately shown in FIG. 6): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some examples, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Various aspects of the present disclosure are described by narrative text, flowcharts, block diagrams of computer systems and/or block diagrams of the machine logic included in computer program product (CPP) examples. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product example ("CPP example" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim.“ A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for operating an Artificial-Intelligence Module (AI-Module), wherein the AI-Module is trained to generate an output dependent on input usage data, the method comprising:
providing the input usage data relating to a request requiring computing resources of a computer system;
approximating a computational demand for executing the AI-Module in order to generate the output;
approximating a benefit of using the AI-Module, wherein the benefit depends on an evaluation of a fulfilment of the request by the computer system in case being operated dependent on the output;
checking whether the computational demand exceeds the benefit; and
disabling the executing of the AI-Module for generating the output in case the computational demand exceeds the benefit.

2. The method of claim 1, wherein the computer system is designed in a form of a mainframe computer.

3. The method of claim 1, wherein the request comprises jobs to be executed by the computer system and the input usage data comprises information about one or more selected from the group consisting of a total number of the jobs, a number of a respective subset of the jobs which are assigned to a respective service class, a current pattern of the jobs, and an association of the jobs to different service classes, wherein the service classes represent different computational requirements for an execution of the jobs by means of the computer system.

4. The method of claim 3, wherein the different computational requirements relate to different performance goals, resource requirements and priority levels of the execution of the jobs.

5. The method of claim 1, wherein the approximating of the benefit comprises determining a benefit score representing the benefit in a form of a number, wherein the approximating of the computational demand comprises determining a demand score representing the computational demand in the form of a further number, and wherein the computational demand exceeds the benefit in case the demand score is greater than the benefit score.

6. The method of claim 1, wherein the request specifies jobs to be executed by means of the computer system and the benefit depends on a saving of total waiting time for the jobs to be completed by means of the computer system.

7. The method of claim 1, wherein the request specifies jobs to be executed by means of the computer system and the jobs are assigned to different priority levels and the benefit depends on weighted savings of waiting times for the jobs to be completed by means of the computer system, wherein the saving of the waiting time for the respective job is weighted dependent on the priority level to which the respective job is assigned to.

8. The method of claim 1, wherein the computational demand for executing the AI-Module in order to generate the output comprises a network utilization demand due to a usage of a network of the computer system which provides a communication link for a communication between the AI-Module and a requesting unit, wherein the communication between the AI-Module and the requesting unit comprises sending the input usage data from the requesting unit to the AI-Module and sending the output from the AI-Module to the requesting unit.

9. The method of claim 1, wherein the AI-Module is configured to generate the output dependent on the input usage data and historical data about past requests requiring computing resources of the computer system and the computational demand comprises a computational demand for performing computational steps for generating the output on a basis of the input usage data and the historical data.

10. The method of claim 9, wherein the computational demand for executing the AI-Module in order to generate the output comprises a computational demand for transferring the historical data from a data storage to the AI-Module.

11. The method of claim 9, wherein the historical data about past requests comprises for the respective past request a respective value of a performance metric and information about whether the AI-Module was used for fulfilling the respective past request, wherein the respective value of the performance metric indicates an evaluation of fulfilment of the respective past request by the computer system, and the approximating of the benefit involves approximating the benefit on the basis of the historical data.

12. The method of claim 9, wherein the historical data about the past requests comprises information about one or more selected from the group consisting of a total number of past jobs submitted within past time intervals, a number of a respective subset of the past jobs which are assigned to a respective service class and historical patterns of the past jobs, and an association of the past jobs to different service classes, wherein the service classes represent different requirements for an execution of the past jobs by means of the computer system.

13. The method of claim 12, wherein the AI-Module is configured to generate the output dependent on a similarity between a current pattern and the historical patterns.

14. The method of claim 12, wherein the approximating of the benefit comprises determining a pattern similarity score, wherein the pattern similarity score indicates a similarity between a current pattern and the historical patterns, and wherein the disabling of the executing of the AI-Module is performed in case the pattern similarity score is less than a given first threshold.

15. The method of claim 9, wherein the input usage data comprises information about a daytime, a weekday, or a month at which the request is pending, wherein the approximating of the benefit comprises predicting a future demand of computing resources of the computer system on the basis of the information about the daytime, the weekday and/or the month at which the request is pending using the historical data, the method further comprising disabling the executing of the AI-Module for generating the output in case the predicted future demand is less than a given second threshold.

16. The method of claim 1, wherein the request comprises jobs to be executed by the computer system and the computer system being operated dependent on the output comprises setting a number of initiator processes to be executed on the computer system dependent on the output, wherein an executing of the initiator processes on the computer system involves initiating an execution of the jobs and the evaluation of the fulfilment of the request by the computer system depends on the number of the initiator processes to be executed.

17. The method of claim 1, the method further comprising performing the disabling of the executing of the AI-Module for generating the output in case a current workload of the computer system is greater than a given third threshold.

18. The method of claim 1, the method further comprising performing the disabling of the executing of the AI-Module for generating the output in case a current workload of the computer system is less than a given fourth threshold.

19. A computer program product comprising a computer-readable storage medium having computer-readable program code embodied therewith, the computer-readable program code being readable by a computing system to cause the computing system to perform a method comprising:
providing input usage data relating to a request requiring computing resources of a computer system;
approximating a computational demand for executing an AI-Module in order to generate an output;
approximating a benefit of using the AI-Module, wherein the benefit depends on an evaluation of a fulfilment of the request by the computer system in case being operated dependent on the output;
checking whether the computational demand exceeds the benefit; and
disabling the executing of the AI-Module for generating the output in case the computational demand exceeds the benefit.

20. A computer system for operating an Artificial-Intelligence Module (AI-Module) wherein the AI-Module is trained to generate an output dependent on input usage data, wherein the computer system is configured to:
provide the input usage data relating to a request requiring computing resources of a computer system;
approximate a computational demand for executing the AI-Module in order to generate the output;
approximate a benefit of using the AI-Module, wherein the benefit depends on an evaluation of a fulfilment of the request by the computer system in case being operated dependent on the output;
check whether the computational demand exceeds the benefit; and
disable the executing of the AI-Module for generating the output in case the computational demand exceeds the benefit.
